(19) United States
(12) Patent Application Publication
(10) Pub. No.: US 2021/0352770 A1
(43) Pub. Date: Nov. 11, 2021

(54) PTC Heating Assembly and Electric Heating Device Comprising the Same

(71) Applicant: Eberspacher catem GmbH & Co. KG, Herxheim (DE)

(72) Inventors: Kurt Walz, Hagenbach (DE); Ahmad Asafi, Karlsruhe (DE); Kai-Fabian BÜrkle, Hinterweidenthal (DE); Stefan Plewnia, Karlsruhe (DE)

(21) Appl. No.: 17/314,676

(22) Filed: May 7, 2021

(30) Foreign Application Priority Data
May 8, 2020 (DE) 10 2020 112 553.4

(51) Int. Cl. H05B 3/24; H01C 1/14; H01C 7/02; H05B 3/03

(52) U.S. Cl. CPC H05B 3/24; H01C 1/1406; H01C 7/023; H05B 2203/017; H05B 3/03; H05B 2203/02; H05B 2203/016; H01C 7/021

(57) ABSTRACT

APTC heating assembly includes contact elements and a cuboid ceramic component on which a metallization is applied. The ceramic component comprises mutually opposing main side surfaces for heat dissipation which are larger by at least a factor of five than each of the end faces extending between the main side surfaces. The contact elements are electrically conductively connected to the metallization for introducing the power current into the ceramic component. The metallization is formed only on the main side surfaces and is in the form of elongated metallization strips. The metallization strips extend along mutually opposite edges of the cuboid ceramic component, are each assigned to one polarity, are separated by a single end face, and are connected to a power source via a common contact element.

### BACKGROUND OF THE INVENTION

### 1. Field of the Invention

The present invention relates to a PTC heating assembly with a ceramic component. The ceramic component is cuboid-shaped. A metallization is applied to the ceramic component. The ceramic component has opposing main side surfaces which serve at least predominantly for heat dissipation. These main side surfaces are characterized by the fact that they are larger by at least a factor of five than each of the end faces, which are formed as a circumferential edge and extend between the two main side surfaces. Furthermore, at least two contact elements are provided which serve to introduce the power current and are electrically conductively connected to the metallization.

### 2. Background of the Invention

Such a PTC heating assembly is known, for example, from DE 10 2016 424 296 A1.

The contact element serves to introduce the power current into the ceramic component. The ceramic component usually consists of a thermistor material. This thermistor material consists of semiconducting ceramic particles. The ceramic particles are sintered to create the ceramic component. The ceramic component can be disc-shaped or cuboid-shaped. In the applications in question here, the ceramic component is usually formed as a thin cuboid with opposing main side surfaces that are substantially larger than the end faces connecting these two main side surfaces.

Those surfaces of the ceramic component, which are used to introduce the power current, are usually provided with the metallization. This metallization is applied as a layer to the ceramic material, for example sputtered or vapor-deposited. The commercially available ceramic component, which is usually used in heating devices, usually has the corresponding metallization for current introduction not only on the ceramic material but also on opposing surfaces.

The contact elements are applied to these metallized surfaces of the ceramic component. There are various possibilities for this. It is possible to bond the contact elements to the ceramic component. The adhesive can be an electrically conductive adhesive. It can also be electrically non-conductive in itself and be provided with electrically conductive particles which conduct the current from the contact element to the metallization. The surface of the ceramic components has a not insignificant roughness. For example, an electrically non-conductive adhesive is sometimes used, which is partially displaced by external pressure when the contact elements are applied so that roughness peaks directly contact the contact element, but the contact element is nevertheless connected to the ceramic component via the non-electrically conductive adhesive.

It is also possible to solder the contact elements to the ceramic component. In this case, the contact element is placed on the ceramic component, especially the metallization provided on it. The solder is applied to this metallization and to the surfaces of the contact element to form a material bond between the contact elements and the ceramic component.

The ceramic material of the sintered ceramic component is relatively brittle. The ceramic component must therefore be subjected to gentle mechanical stress both during manufacture and in the scope of the connection between the ceramic component and the contact element and also when used in an electric heating device.

In addition, the ceramic component is a thermistor. These thermistors are used in particular in the field of automotive engineering, since their electrical resistance increases with rising temperature. Above the Curie temperature, the lack of polarization within the ceramic component results in an insulating effect so that the electrical resistance due to the ceramic component increases exponentially. This self-regulating effect is positive when it comes to avoiding overheating of the ceramic component and thus of the heating device. On the other hand, poor heat extraction from the ceramic component has a negative effect on efficiency. Thus, the actually installed heat output cannot be maintained.

In light of this, those skilled in the art strive to minimize thermal resistance as much as possible between the ceramic material of the ceramic component and the outside of a heating cell or electric heating device used to utilize the heat of a ceramic component.

### SUMMARY

The present invention is based on the problem of providing a PTC heating assembly and a heating device comprising such a PTC heating assembly, which enables heat to be dissipated of the ceramic component with reduced resistance in the heat conduction path from the main side surfaces to the outside of the PTC heating assembly.

In order to solve this problem, the present invention discloses a PTC heating assembly including a cuboid ceramic component on which a metallization is applied. The ceramic component comprises mutually opposing main side surfaces for heat dissipation and first and second end faces extending between the main side surfaces. The main side surfaces are larger by at least a factor of five than each of the end faces. The contact elements are electrically conductively connected to the metallization for introducing a power current into the ceramic component via the metallization The metallization is formed only on the main side surfaces and are provided in the form of elongated metallization strips along opposing edges of the cuboid ceramic component. Two metallization strips are assigned to one common polarity and are separated by a single end face and connected to the power current via a common contact element. The common contact element accordingly contacts the two metallization strips.

In the configuration according to the invention, the two metallization strips assigned are located on opposite main side surfaces on one longitudinal side of the cuboid ceramic component. The metallization strips usually extend exclusively over the main side surfaces of the ceramic component. They usually end with the edge that forms the end face separating the metallization strips from each other with the associated main side surface.

The length of the metallization strip usually corresponds to the length of the ceramic component. The length is the largest extension of the ceramic component. The length spans the corresponding main side surface with the width. The length spans with the height opposite longer end faces. These end faces separate the metallization strips of a single polarity from each other. Together with the height, the width spans the shorter end faces extending at right angles to it. Accordingly, the metallization strips on the main side surface usually extend from one shorter end face to the other shorter end face and also end there with that edge which is formed between the main side surface and the shorter end face. The width of the metallization strips, i.e. their extension in the direction of the width of the ceramic component is usually not more than 10%, and more typically not more than 5%, of the total width of the ceramic component.

The metallization can be applied to the surface of the ceramic component by sputtering or vapor deposition in a manner known. The metallization strips are provided isolated from each other on the ceramic surface of the ceramic component. Usually, only four metallization strips are applied to the two main side surfaces of the ceramic component. Further center insulations are lacking. The four metallization strips are the only metallization and on the surface of the ceramic component. The remaining surface portions of the ceramic component are made of ceramic The metallization strips can be continuous in the longitudinal direction or formed in this direction by several electrically separate islands which are contacted via a common contact element.

The two metallization strips assigned to one polarity are contacted to a power source via a common contact element for receiving power current. Accordingly, the power current is introduced into the ceramic component via the metallization strips using at least two contact elements, each of which is assigned to one polarity.

The contact element usually encompasses the main side surfaces and rests on the opposing main side surfaces. It goes without saying that the contact element does not rest directly on the ceramic surface of the main side surfaces, but usually only and exclusively on the surface portions formed by the metallization strips.

The contact element can be connected to these metallization strips in a materially bonded manner and thus by means of welding, soldering or bonding, in particular bonding with an electrically conductive adhesive.

With regard to simple contacting, the contact element is designed as a claw. This claw has two essentially parallel legs which abut against the opposite main side surfaces and are in direct contact there with the metallization strips. For this purpose, the opposing inner surface of the legs may have a convex projection which abuts against the metallization in a punctiform manner or as an elongated ridge in a linear manner in order to introduce the power current from the contact element into the metallization strips. The claw has a web provided between the two legs. This web extends substantially parallel to the end face, in particular the longer end face. An insulation may be provided between the web and the end face to prevent charge carriers from being introduced into end faces via the web.

The claw is usually connected to the ceramic component via a clamp connection. Accordingly, the claw abuts against the ceramic component under a certain preload.

The present invention is guided by the concept that the metallization strips of different polarity are provided at opposite ends in the width direction of the cuboid ceramic component. The metallization is recessed at the circumferential end faces. Thus, charge carriers can only migrate from one edge to the other edge in the width direction and penetrate the ceramic component, thereby heating it. In this context, it is assumed that the power current also passes diagonally through the ceramic component and is accordingly conducted from a metallization strip on one main side surface to the metallization strip on the opposite main side surface and the opposite side of the ceramic component.

The PTC heating assembly of the aforementioned type can be configured in a manner known in principle from DE 10 2016 224 296 A1. In this prior art, an insulating layer abuts directly against the main side surfaces of the ceramic component in a thermally conductive manner Thus, heat dissipation takes place directly without an intermediate layer of metallization or a contact element via the main side surfaces. Such a configuration can also be selected in the present case if the insulating layer is applied to the ceramic component over its entire surface, for example by means of a good heat-conducting adhesive, usually with the application of an external driving force. The ceramic layer can be limited to those parts of the main side surfaces that are not metallized. Alternatively, the ceramic layer can also cover the entire main side surface, sometimes even projecting beyond the cuboid ceramic component at one or more, usually all, edges to increase clearance and creepage distances.

As known from DE 10 2016 224 296 A1, the free ends of the ceramic layers together with the contact elements provided at the edges can be surrounded by an insulating material, usually completely enclosed therein. This insulating material can be an electrically high-quality plastic which surrounds the ceramic component in the manner of a frame and leaves the main side surfaces essentially free in order to dissipate heat there either directly or through an insulating layer applied to the main side surfaces from the ceramic component on the outside of the PTC heating assembly.

Each contact element can be made of a sheet metal strip and form a contact lug at its free end for electrically contacting the PTC heating assembly.

The present invention further relates to an electric heating device with at least one PTC heating assembly arranged in a circulation chamber with a housing which joins at least one ceramic component and a contact element as a structural unit. The electric heating device according to the present invention further has a partition wall separating the circulation chamber from a terminal chamber of the heater housing, wherein in the terminal chamber the contact lugs of the PTC heating device projecting through the partition wall are exposed and electrically connected.

An electric heating device of the aforementioned type is also known from DE 10 2016 224 296 A1.

The present invention, with this parallel aspect, aims to provide an electric heating device, in particular for a motor vehicle, in which heat extraction from the PTC ceramic is possible with reduced resistance in the heat conduction path.

The present invention relates in particular to an electric heating device for a motor vehicle and to a PTC heating assembly of such an electric heating device. In the case of electric heating devices with PTC heating assemblies, configurations are to be preferred which allow the heat generated in the ceramic component to be dissipated as well and as symmetrically as possible.

In order to solve the problem, the second aspect of the present invention proposes a PTC heating assembly that includes at least one heater housing having a circulation chamber and a connection chamber separated by a partition wall. A PTC heating assembly is arranged in the circulation chamber and includes at least one ceramic unit, contact elements, a housing which joins the ceramic component and the contact elements as a structural unit, and contact lugs which project through the partition wall and into the connector chamber and which are configured to be connected to a power source. The PTC heating assembly may be configured as described above. The PTC heating assembly can be sealingly inserted into the partition wall in the manner of a male plug-in element and/or held therein. For this purpose, the PTC heating assembly is usually provided with sealing lips or lamellas, at least in the area of the plug-in contact, which cooperate in a sealing manner with a female plug-in contact receptacle formed by the partition wall.

### BRIEF DESCRIPTION OF THE DRAWINGS

Further details and advantages of the present invention will be evident from the following description of embodiments in conjunction with the drawing. Therein:

FIG. 1 shows a perspective front side view of an embodiment of a ceramic component with the metallization provided thereon;

FIG. 2 shows a schematic side view of the embodiment according to FIG. 1 with a first embodiment of a contact element;

FIG. 3 shows a side view according to FIG. 2 for a further embodiment of a contact element;

FIG. 4 shows a side view according to FIG. 2 with an electrically insulating overmold, and

FIG. 5 shows a perspective, partially sectional view of an electric heating device that includes several embodiments of the heat-generating element therein.

### DETAILED DESCRIPTION

FIG. 1 shows a cuboid ceramic component 2 which has two opposing main side surfaces 4 spanned by the width B and the length L of the cuboid ceramic component 2. In the direction of the length L and in the direction of the height H, the longer end faces 6 extend. At right angles to this and at right angles to the main side surfaces 4, shorter end faces 8 extend.

It is evident that metallization strips 10, 12 are provided on the opposite main side surfaces 4. The metallization strips 10, 12 each have an equal width b. This width b corresponds to approximately 5% of the width B of the ceramic component 2. The metallization strips 10, 12 are applied solely to the main side surfaces 4. The metallization strips 10, 12 are generated by sputtering an electrically conductive material onto the ceramic surface of the ceramic component 2. The two metallization strips 10 are assigned to one polarity, the two metallization strips 12 are assigned to another polarity.

The longer and shorter end faces 6, 8 form a circumferential edge on the cuboid ceramic component 2. Each of the end faces 6, 8 is substantially smaller than each of the main side surfaces 4. Thus, the main side surfaces 4 form those surfaces for the predominant dissipation of the heat generated by the ceramic component.

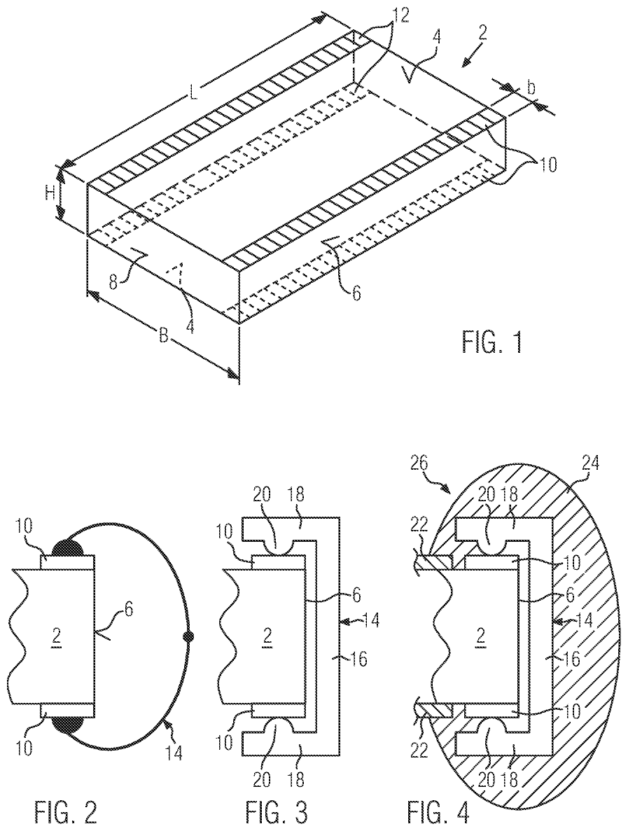

FIG. 2 shows a side view of a lateral edge of an embodiment of the present invention with a contact element characterized by reference sign 14. The contact element 14 directly contacts the two opposing metallization strips 10. The contact element 14 is soldered to the metallization strip 10 and is thus connected by a material bond.

FIG. 3 shows an alternative embodiment. There, the contact element 14 consists of a claw with a central web 16 and opposite legs 18, from which convexly curved contact projections 20 project inwardly, which are connected directly to the surface with metallization strips 10 by clamping. An insulating layer, for example in the form of a plastic film, can be provided between the web 16 and the longer end face 6 in order to prevent electrical contact between the contact element 14 lying on a polarity and the end face 6.

As illustrated in FIGS. 2 and 3, the power current is introduced only via the metallization strips 10, 12. From there, the power current traverses the ceramic component 2 to the respective other polarity. As a result, the ceramic component 2 heats up.

In the embodiment shown in FIGS. 2 and 3, there is usually an insulating layer between the metallization strips 10, 12. This insulating layer may form outer surface of the PTC heating assembly.

FIG. 4 shows a sectional view of a variant in which an insulating layer 22 in the form of a ceramic plate or plastic film is applied to the area of the main side surface 4 not provided with the metal strip 10, 12. The edge region of the insulating layer 22 extending in the longitudinal direction L is overlapped by the legs 18 of the contact element 14 and accordingly is mechanically secured. FIG. 4 further illustrates an over-mold of an electrically insulating plastic, characterized by reference sign 24, which overlaps the rail-shaped contact element 14, as well as an extended edge region of the insulating layer 22 and seals the contact element 14. Thus, the outer surface of the insulating layer 22 forms the heat-emitting outer surface of a PTC heating assembly characterized by reference sign 26. The outer circumferential surface of this PTC heating assembly is essentially formed by the overmold 24. On one edge side, this frame-shaped overmold 24 is protruded by contact lugs formed by the free ends of the rail-shaped contact element 14. This can be trimmed to form a flat contact lug so that only one of the legs 18 or the web 16 projects beyond the overmold 24 as a contact lug.

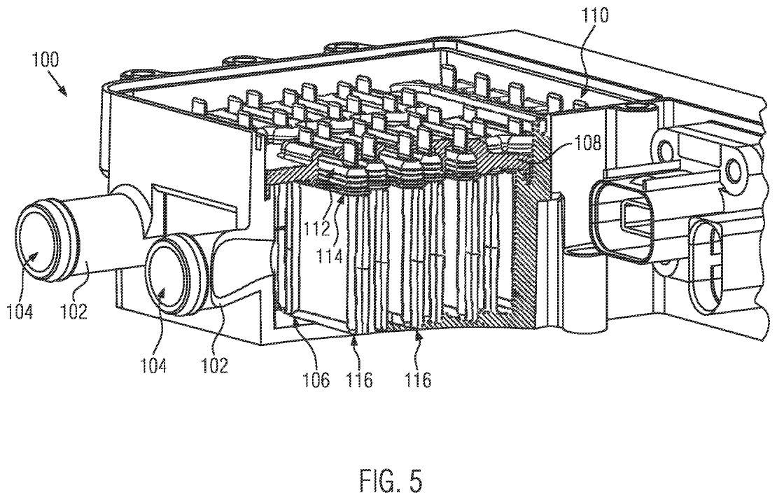

The installation of several PTC heating assemblies, constructed in a corresponding manner, in an electric heating device of a motor vehicle for heating a liquid or gaseous medium is illustrated in FIG. 5. In FIG. 5, the heating assembly is identified with reference numeral 116. The electric heating device has a heater housing 100 made of plastic and characterized by reference sign 100. The heater housing 100 forms inlet and outlet ports 102 which define respective inlet and outlet openings 104 leading to a circulation chamber 106 which is fluid-tightly separated from a connection chamber characterized by reference sign 110 by a cover forming a partition wall 108. The partition wall 108 forms receptacles 112, which are formed as female plug-in elements of a fluid-tight plug-in connection which is effected by inserting a sealing collar 114 into the receptacle 112. The sealing collar 114 is typically made of a soft elastic plastic, in particular silicone. The sealing collar 114 may be part of the overmold 24 or formed by a separate overmold around it.

In the position shown in FIG. 4, the free ends of the contact lugs protrude into the connection chamber 110 and can be electrically connected there, as described in principle, for example, in EP 3 334 244 A1.

In the embodiment shown here, the cover forms the partition wall 108 which seals the circulation chamber 106 from the connection chamber 110 in a fluid-tight manner and forms the receptacles 112. In the embodiment shown, the cover is inserted into the heater housing as a separate component made of plastic. Other designs are also conceivable in which, for example, a bottom of the heater housing 100 is formed as a separate cover element and the partition wall 108 is integrally formed together with walls of the heater housing 100 defining the connection chamber 110 or the circulation chamber 106 and extending substantially at right angles to the bottom.

1. A PTC heating assembly comprising:
a cuboid ceramic component on which a metallization is applied, wherein the ceramic component comprises mutually opposing main side surfaces for heat dissipation and first and second end faces extending between the main side surfaces, wherein the main side surfaces are larger by at least a factor of five than each of the end faces;
contact elements that are electrically conductively connected to the metallization for introducing a power current into the ceramic component via the metallization, wherein the metallization is formed only on the main side surfaces and is in the form of elongated metallization strips extending along mutually opposing edges of the cuboid ceramic component, and wherein two elongated metallization strips are provided which are each assigned to a common polarity, which are separated by a single end face of the ceramic component, and which are configured to be connected to a power source via a common contact element.

2. The PTC heating assembly according to claim 1, wherein a contact element forms two contact surfaces which abut only against the main side surfaces and of which one contact surface contacts a first metallization strip and the other contact surface contacts a second metallization strip which is separated from the first metallization strip only by an end face.

3. The PTC heating assembly according to claim 1, wherein a contact element is formed as a claw having two substantially parallel extending legs abutting against the opposite main side surfaces and contacting the metallization strips, and a wherein the claw further comprises a web that is provided between the legs and that extends substantially parallel to the end face.

4. The PTC heating assembly according to claim 3, wherein the claw is connected to the ceramic component via a clamp connection.

5. An electric heating device comprising:
at least one heater housing having a circulation chamber and a connection chamber separated by a partition wall;
a PTC heating assembly arranged in the circulation chamber; wherein the PTC heater assembly includes
at least one ceramic unit on which a metallization is applied,
contact elements,
a housing which joins the ceramic component and the contact elements as a structural unit,
contact lugs which project through the partition wall and into the connection chamber and which are configured to be connected to a power source, wherein
the ceramic component comprises mutually opposing main side surfaces for heat dissipation and first and second end faces extending between the main side surfaces, wherein the main side surfaces are larger by at least a factor of five than each of the end faces, wherein
the contact elements are electrically conductively connected to the metallization for introducing a power current into the ceramic component via the metallization, wherein
the metallization is formed only on the main side surfaces and is in the form of elongated metallization strips extending along mutually opposing edges of the cuboid ceramic component, and wherein
two elongated metallization strips are provided which are each assigned to a common polarity, which are separated by a single end face of the ceramic component, and which are configured to be connected to a power source via a common contact element.

6. The Electric heating device according to claim 5, wherein the heating assembly is sealingly inserted into the partition wall.
